(19) United States
(12) Patent Application Publication
(10) Pub. No.: US 2015/0357061 A1
(43) Pub. Date: Dec. 10, 2015

(54) NUCLEAR REACTOR COOLANT PUMP WITH HIGH DENSITY COMPOSITE FLYWHEEL

(71) Applicant: Babcock & Wilcox mPower, Inc., Charlotte, NC (US)

(72) Inventors: Matthew W. ALES, Forest, VA (US); Mark C. GODDEN, Forest, VA (US)

(21) Appl. No.: 14/299,424

(22) Filed: Jun. 9, 2014

(51) Int. Cl. G21C 15/18; B23K 31/02; G21C 21/02

(52) U.S. Cl. CPC G21C 15/182; G21C 21/02; B23K 31/02

(57) ABSTRACT

A nuclear reactor coolant pump (RCP) comprises a stator and a rotating assembly including a rotor, an impeller, and a flywheel configured to rotate about an axis of rotation in response to the stator being electrically energized. The flywheel comprises a first material (such as stainless steel) and has a plurality of mutually parallel tubular openings filled with a second material that is denser than the first material (such as tungsten or tungsten alloy). In some embodiments the mutually parallel tubular openings are cylindrical openings, and are filled with the second material comprising cylindrical rods. In a nuclear reactor including a reactor pressure vessel and a nuclear reactor core comprising fissile ²³⁵U disposed in the reactor pressure vessel, the RCP is suitably disposed on or in the reactor pressure vessel with the impeller of the RCP arranged to engage coolant water disposed in the reactor pressure vessel.

This application was conceived in the course of work supported by the Department of Energy Cooperative Agreement No. DE-NE0000583. The Department of Energy may have certain rights in this application.

### BACKGROUND

The following pertains to the nuclear reactor arts, nuclear power arts, reactor coolant pump arts, and related arts.

A typical nuclear reactor comprises a radioactive reactor core disposed in coolant in a reactor pressure vessel. For example, a light water reactor employs purified water as the coolant, and the reactor core typically comprises a uranium composition such as uranium oxide (UO₂) enriched in the fissile ²³⁵U isotope. In operation, the nuclear reactor core supports a nuclear chain reaction that heats the coolant, and the coolant is brought into thermal communication with secondary coolant (typically water) in a steam generator to convert the secondary coolant to working steam to drive a turbine in the case of an electric power plant, or to perform some other useful work. In a pressurized water reactor (PWR), the steam generator is typically an external unit connected with the reactor pressure vessel by a (primary) coolant loop driven by a reactor coolant pump. In some small modular reactor designs, the steam generator is located inside the reactor pressure vessel (referred to as an integral PWR) and the secondary coolant flows through reactor pressure vessel penetrations into and out of the internal steam generator. Another known light water reactor design is the boiling water reactor (BWR) design. In this design, there is no steam generator and no secondary coolant. Instead, the (primary) coolant in the reactor pressure vessel is directly converted to steam which is piped to and drives a turbine. In these designs, circulation of coolant in the reactor pressure vessel is relied upon to remove heat from the reactor core and to transfer the heat to the steam generator (or directly to the turbine in BWR designs). Except for low power reactors which may rely upon natural circulation, the designed coolant circulation in the reactor pressure vessel is obtained by operation of one or more reactor coolant pumps (RCP's).

In an operation known as SCRAM, the nuclear chain reaction in the reactor core is shut down by rapidly inserting neutron-absorbing control rods into passages in the reactor core. To provide failsafe operation, the control rod insertion is usually gravity-driven, and the control rod drive mechanism (CRDM) is designed to drop the control rod(s) upon a loss of power to the CRDM. Although the nuclear chain reaction is quickly extinguished by SCRAM, the nuclear reactor core continues to output residual decay heat due to continued radioactive decay of intermediate reaction products in the reactor core. Residual decay heat output is highest immediately after SCRAM as the quantity of intermediate reaction products is highest at that time, and the residual decay heat decreases rapidly with time after the SCRAM as short half-life isotopes decay into (more) stable isotopes. Nonetheless, decay heat output remains high for an extended period after the SCRAM, and emergency core cooling (ECC) procedures are employed after the SCRAM to dissipate the decay heat.

As part of the SCRAM procedure, and/or due to a loss of electrical power in some event scenarios, the RCPs are usually shut off at SCRAM initiation. This presents a problem because the RCP shut off terminates coolant circulation at the beginning of SCRAM, when the residual decay heat output of the reactor core is highest.

A way to address this problem is to increase the moment of inertia of the rotating assembly of the RCP. By doing so, the rotating assembly will continue to rotate for a short time (e.g., a few seconds or longer) after power to the RCP is cut, providing continued coolant circulation immediately after initiating SCRAM when the residual decay heat output is highest. The rotating assembly of the RCP includes the impeller, drive shaft, and motor rotor. Modifying these components to increase the moment of inertia can be problematic since such modification can adversely impact their normal operational function.

As an alternative, one or more flywheels may be added to the rotating assembly so as to increase the moment of inertia. Since the moment of inertia increases with density, the flywheel is preferably made of a dense material. Compared with stainless steel, a material such as tungsten provides a usefully large increase in density. However, tungsten can be problematic in the nuclear reactor environment, and also exhibits differential thermal expansion as compared with surrounding steel components. Finegan et al., U.S. Pat. No. 8,590,419 discloses a tungsten flywheel that addresses these issues by forming a flywheel as a set of tungsten wedges separated by gaps to accommodate thermal expansion, banding the tungsten wedges together with an outer hoop, and adding an inner hoop and upper and lower caps to encase the tungsten.

### BRIEF SUMMARY

In some embodiments described herein as illustrative examples, a reactor coolant pump comprises a stator and a rotating assembly including a rotor, an impeller, and a flywheel. The rotating assembly is configured to rotate about an axis of rotation in response to the stator being electrically energized. The flywheel comprises a first material and has a plurality of cylindrical openings whose axes are mutually parallel and are parallel with the axis of rotation of the rotating assembly. The flywheel further includes cylindrical elements of a second material denser than the first material disposed in the cylindrical openings. In some embodiments the first material comprises steel and the second material comprises tungsten or a tungsten alloy. In some embodiments the flywheel is a circular cylindrical flywheel whose axis is coincident with the axis of rotation of the rotating assembly. In some embodiments the reactor coolant pump is configured as a wet rotor reactor coolant pump, and the outer cylindrical surface of the circular cylindrical flywheel has a surface texture, for example comprising surface dimples, configured to reduce fluid resistance of the rotating assembly in water.

In some embodiments described herein as illustrative examples, a reactor coolant pump comprises a stator and a rotating assembly including a rotor, an impeller, and a flywheel. The rotating assembly is configured to rotate about an axis of rotation in response to the stator being electrically energized. The flywheel comprises a first material and has a plurality of mutually parallel tubular openings filled with a second material that is denser than the first material. In some embodiments the second material is tungsten, a tungsten alloy, or depleted uranium. In some embodiments the mutually parallel tubular openings are filled with the second material comprising pellets, beads, or rods. In some embodiments the flywheel further comprises build-up welds sealing the parallel tubular openings. In some embodiments the flywheel further comprises at least one end plate sealing the parallel tubular openings.

In some embodiments described herein as illustrative examples, a nuclear reactor includes a reactor coolant pump as set forth in either one of the two immediately preceding paragraphs, a reactor pressure vessel, and a nuclear reactor core comprising fissile ²³⁵U disposed in the reactor pressure vessel. The reactor coolant pump is disposed on or in the reactor pressure vessel with the impeller of the reactor coolant pump arranged to engage coolant water disposed in the reactor pressure vessel.

In some embodiments described herein as illustrative examples, a method comprises: providing a flywheel comprising a first material; drilling cylindrical openings in the flywheel oriented parallel with an axis of rotation of the flywheel; disposing a second material that is more dense than the first material in the cylindrical openings; and after disposing the second material in the cylindrical openings, sealing the cylindrical openings. The sealing may comprise welding a build-up weld to seal each cylindrical opening. The method may further comprise mounting the flywheel on the rotating assembly of a reactor coolant pump.

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention. This disclosure includes the following drawings.

FIG. 1 diagrammatically shows a partial cutaway perspective view of an illustrative nuclear reactor of the integral pressurized water reactor (integral PWR) variety, and further shows on the right side an enlarged partial cutaway perspective view of an illustrative reactor coolant pumps (RCP) of the integral PWR.

FIG. 2 diagrammatically shows a perspective view of a flywheel.

FIG. 3 diagrammatically shows a perspective view of the flywheel of FIG. 2 being loaded with second (denser) material in the form of cylindrical rods of said second (denser) material.

FIG. 4 diagrammatically shows a perspective view of the complete flywheel assembly including build-up welds sealing the cylindrical openings of the flywheel of FIG. 2 after being loaded with second (denser) material as shown in FIG. 3.

FIG. 5 diagrammatically shows a perspective view of an alternate embodiment in which a sealing plate seals the cylindrical openings of the flywheel of FIG. 2 after being loaded with second (denser) material as shown in FIG. 3.

FIG. 6 diagrammatically shows a perspective view of an alternate embodiment in which the circular cylindrical flywheel of FIGS. 2-5 is replaced by a solid structure without a through hole.

### DETAILED DESCRIPTION OF THE PREFERRED EMBODIMENTS

Disclosed herein are high density composite flywheels that provide the advantages of increased density as compared with a steel flywheel while maintaining ease of manufacturing and efficient use of the high density (e.g. tungsten) material. The disclosed flywheels are based on several observations.

The moment of inertia I of a rotating body (e.g. flywheel) can be calculated as I=∫_{V} ρ(r)r² where r is a radius vector to a point in the body from the axis of rotation, and ρ(r) is the mass density at that point. For a cylindrical flywheel that includes a given mass of high density material (e.g. tungsten), increased moment of inertia I is seen to be obtained by preferentially locating the high-density material outboard, that is, relatively nearer to the outer circumference of the cylindrical flywheel, corresponding to large radius (r) values. The contribution to the integral I goes with the square of the radius (r²), making this a super-linear effect.

It is also recognized herein that stock high-density material, such as stock tungsten, is typically commercially available in the form of rods. Thus, a design which employs tungsten rods (or rods of another high-density material) enables the use of commercially available stock, and reduces manufacturing complexity/time as compared with designs that employ otherwise-shaped high-density material components.

It is further recognized herein that the process of encasing the high density material in a steel case substantially increases the complexity and time for manufacturing and assembly.

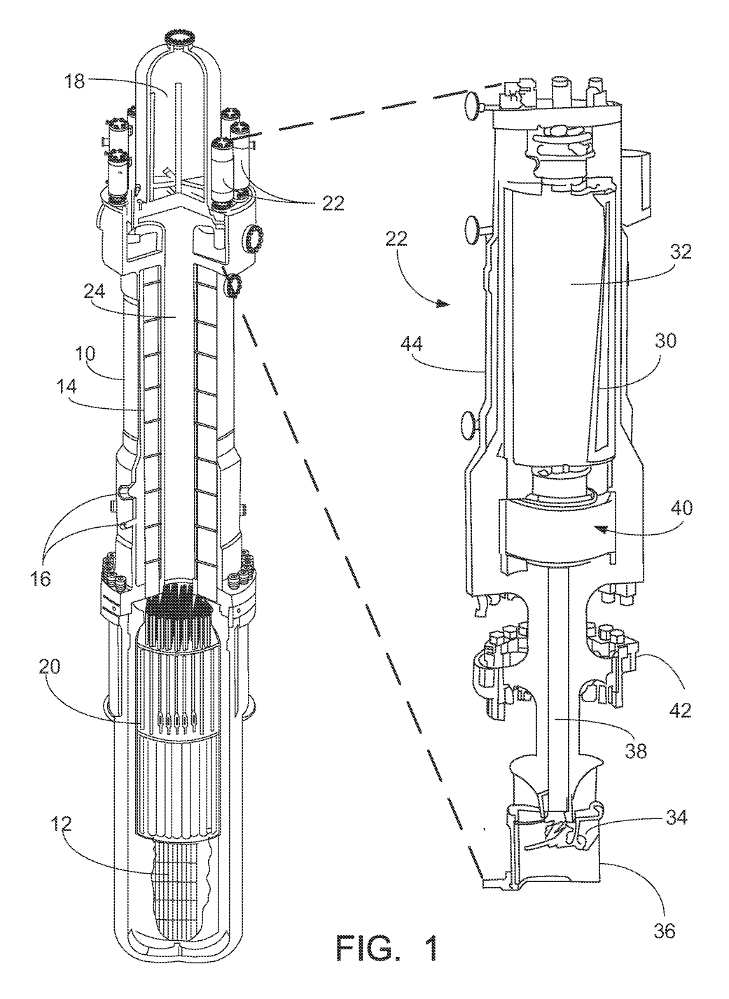

With reference to FIG. 1, an illustrative nuclear reactor (shown in partial cutaway to reveal internal components) includes a reactor pressure vessel 10 and a nuclear reactor core 12 comprising fissile ²³⁵U disposed in the reactor pressure vessel 10. During operation, the reactor pressure vessel is filled with (primary) coolant, such as purified water in the case of a light water reactor, and the nuclear reactor core 12 is immersed in the coolant. The illustrative nuclear reactor of FIG. 1 is an integral pressurized water reactor (integral PWR) that includes an internal steam generator 14 disposed in the reactor pressure vessel 10. Vessel penetrations 16 admit feedwater to the steam generator 14 and output steam from the steam generator 14 which is suitably used to drive a turbine of an electric power plant or to perform other work. The feedwater and steam comprise secondary coolant that is in fluid separation from the (primary) coolant that fills the pressure vessel 10. The steam generator 14 suitably includes structures such as tubes-and-shell structures that bring primary and secondary coolant into thermal proximity while maintaining the fluid separation. The illustrative integral PWR further includes an integral pressurizer volume 18 at the top of the reactor pressure vessel 10 that, during reactor operation, contains a steam bubble that may be heated or cooled using resistive heaters, spargers, or so forth in order to control pressure of the (primary) coolant in the reactor pressure vessel 10. The illustrative integral PWR also includes internals 20 such as control rods and associated control rod drive mechanisms (CRDMs) for modulating the nuclear chain reaction in the reactor core 12 and for shutting down that chain reaction when appropriate.

During operation, the coolant circulates through the reactor pressure vessel 10 in order to cool the nuclear reactor core 12 and transfer heat from the reactor core to the steam generator 14 to convert the secondary coolant feedwater into steam. Toward this end, reactor coolant pumps (RCPs) 22 are provided to circulate the coolant. The illustrative RCPs 22 are located near the top of the reactor pressure vessel 10, proximate to the pressurizer volume 18. However, the reactor coolant pumps may be located elsewhere. The illustrative integral PWR employs a coolant circuit in which the coolant heated by the reactor core 12 rises through a central passage defined by a central riser structure 24 disposed in the reactor pressure vessel 10 and returns to the bottom of the reactor core 12 via an outer annulus (sometimes called a “downcomer” annulus) defined between the reactor pressure vessel 10 and the downcomer annulus 24. The steam generator 14 is disposed in this annulus.

With continuing reference to FIG. 1, an illustrative RCP 22 is shown in enlarged detail on the right-hand side of FIG. 1, shown in partial cutaway to reveal internal components. The RCP 22 includes a motor comprising stator 30 and a rotor 32, and an impeller 34 disposed in an impeller casing 36. A drive shaft 38 connects the impeller 34 and the rotor 32. In operation, the stator 30 is electrically energized, and motor action between the stator 30 and rotor 32 causes rotation of a rotating assembly that includes the rotor 32, impeller 34, connecting drive shaft 38, and a flywheel sub-assembly 40 that is mounted on (and part of) the rotating assembly. Rotation of the rotating assembly rotates the impeller 34 in particular, which drives circulation of the coolant in the reactor pressure vessel 10. The illustrative RCP 22 has its motor (stator 30 and rotor 32) located outside of the pressure vessel, and the illustrative RCP 22 is mounted via a flange 42 to the reactor pressure vessel 10 with the impeller 34 and its casing 36 arranged inside the pressure vessel 10 so as to engage coolant water disposed in the reactor pressure vessel 10 to drive its circulation. The illustrative RCP 22 is configured as a canned rotor reactor coolant pump in which the seal at the flange 42 is not watertight and (primary) coolant from the reactor pressure vessel 10 enters into an external pump housing 44 so that the rotor 32 as well as the flywheel sub-assembly 40 are immersed or at least in contact with primary coolant. In alternative embodiments, the seal at the flange 42 is watertight so that the rotor and flywheel are dry.

The illustrative integral PWR of FIG. 1 is merely an example, and RCPs 22 with flywheels as disclosed herein can be employed in various pump configurations and in various reactor configurations. For example, the RCPs may be located elsewhere besides in the illustrative upper position shown in FIG. 1, such as at a connecting mid-flange of the pressure vessel. Moreover, while the illustrative RCP 22 has its motor located outside of the pressure vessel 10, in other embodiments the RCP may include a canned motor and the entire RCP including the canned motor may be located inside of the pressure vessel. In PWR embodiments employing external steam generators, the RCP may be connected at a large-diameter pipe that forms the coolant flow loop that carries (primary) coolant water between the reactor pressure vessel and the external steam generator. As another example of a variant reactor configuration, in a typical boiling water reactor (BWR) the RCPs are located underneath the reactor pressure vessel, this arrangement being typically chosen because steam separator and other steam-related components are located in the upper portion of the BWR pressure vessel.

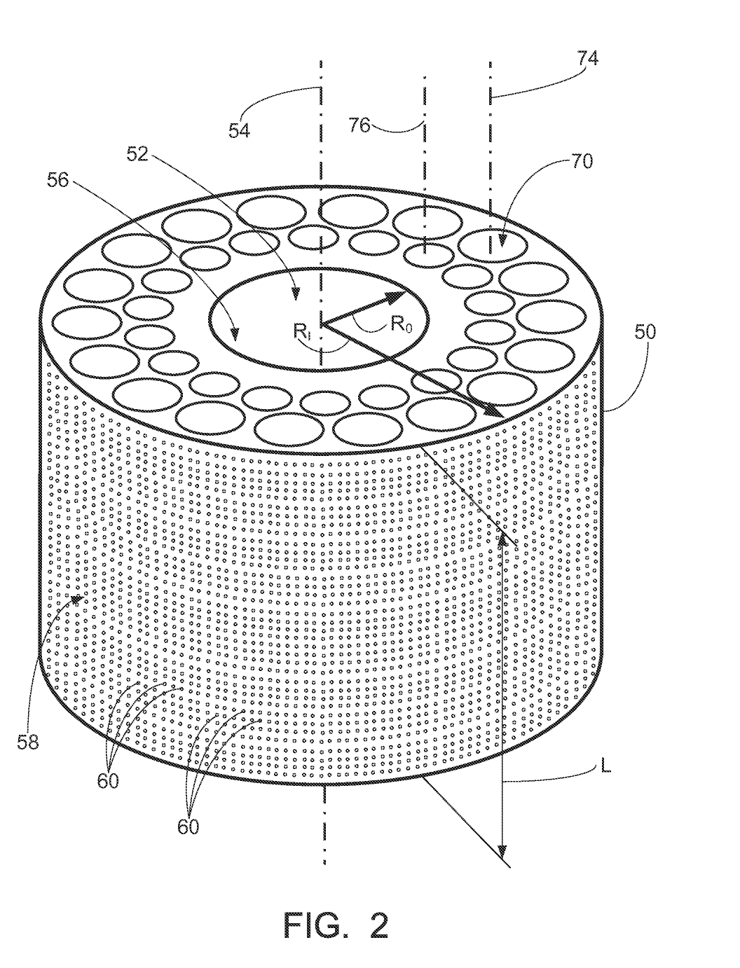

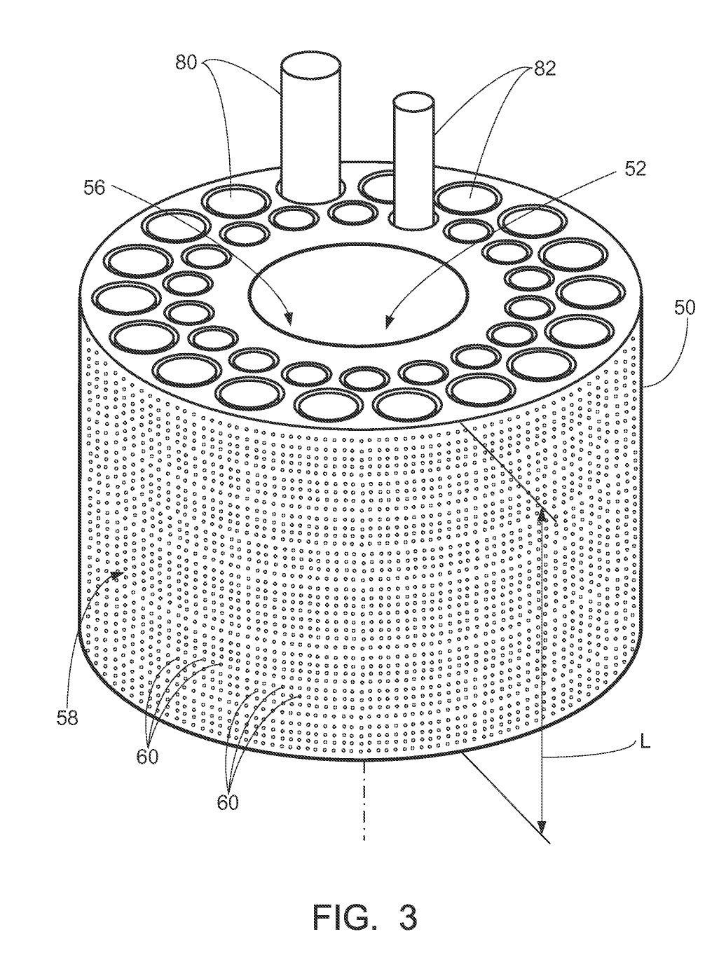

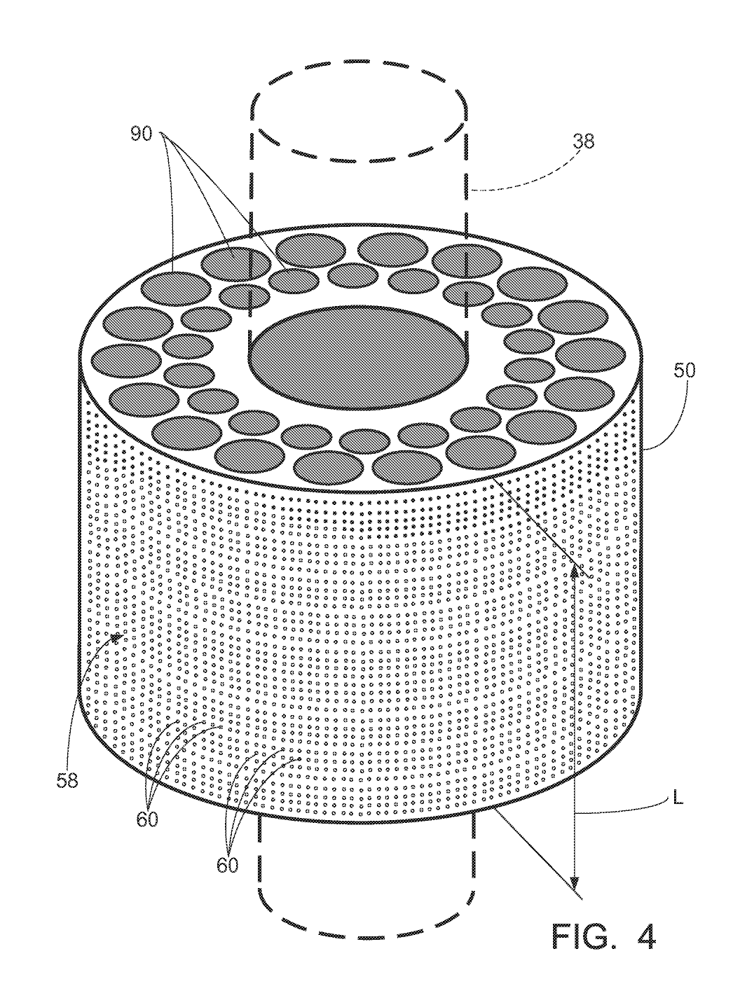

With continuing reference to FIG. 1 and with further reference to FIGS. 2-4, an illustrative embodiment of the flywheel sub-assembly 40 is described. FIG. 2 shows the flywheel 50. FIG. 3 shows the flywheel 50 being loaded with higher density material as described herein. FIG. 4 shows an embodiment of the final assembled flywheel as further described herein.

The illustrative flywheel 50 is a circular cylindrical flywheel 50, and more particularly is circular cylindrical flywheel 50 that includes a hollow portion comprising a central cylindrical opening 52 that is sized to receive the drive shaft 38 of the RCP 22, so that the axis of the circular cylindrical flywheel 50 is coincident with the axis of rotation 54 of the rotating assembly. Note that the driveshaft 38 is shown in phantom only in FIG. 4 for illustration. By mounting the flywheel 50 to the drive shaft 38 via the central cylindrical opening 52, a rotating assembly is constructed that also includes the rotor 32 and impeller 34 connected by the drive shaft 38. This rotating assembly, including the flywheel 50, is configured to rotate about an axis of rotation 54 (diagrammatically indicated only in FIG. 2 for illustration) in response to the stator 30 of the RCP 22 being electrically energized. The central cylindrical opening 52 is sized to receive the drive shaft 38 by having a radius (R_{I} shown only in FIG. 2) respective to the axis of rotation 54 that is sized to comport with the drive shaft diameter. The mounting of the flywheel 50 on the driveshaft 38 may also include other mounting features such as a keying feature (not shown, e.g. a flat area on the drive shaft that mates with a flat area of the central cylindrical opening) to lock the flywheel 50 against rotation relative to the drive shaft 38 so that the flywheel 50 rotates with the drive shaft 38. Alternatively, bolts or other fasteners, welds, a friction fit, or other mechanism (features not shown) can be employed to prevent rotation or slippage of the flywheel relative to the drive shaft 38.

The illustrative circular cylindrical flywheel 50 has an inner cylindrical surface 56 of radius R_{I} respective to the axis of rotation 54 formed by (or defining) the central cylindrical opening 52, and has an outer cylindrical surface 58 of radius R_{O} respective to the axis of rotation 54. The radii R_{I} and R_{O} are indicated only in FIG. 2. The outer cylindrical surface 58 optionally has a surface texture configured to reduce fluid resistance of the rotating assembly in water, such as illustrative surface dimples 60. The optional surface texture 60 to reduce fluid resistance in water is advantageous in the case of the illustrative RCP of a wet rotor design in which the flywheel 50 is in contact with coolant water, but may also be advantageous in a dry rotor RCP (in which case the surface texturing is preferably configured to reduce fluid resistance of the rotating assembly in air).

As seen in FIG. 2, the flywheel 50 has a plurality of cylindrical openings whose axes are mutually parallel and are parallel with the axis of rotation 54 of the rotating assembly. In the illustrative example, the plurality of cylindrical openings include a first set of cylindrical openings 70 at a relatively larger radius respective to the axis of rotation 54, and a second set of cylindrical openings 72 at a relatively smaller (but still relatively large) radius respective to the axis of rotation 54, with illustrative axes 74, 76 labeled for illustrative openings of the first set 70 and second set 72, respectively. It is noted that the circular cylindrical flywheel 50 comprises a first material, such as stainless steel, Inconel, or so forth.

In a suitable machining process, the plurality of cylindrical openings 70, 72 are suitably formed by a drilling process, which typically produces cylindrical openings. The cylindrical openings 70, 72 may pass entirely through the length (or height) L of the circular cylindrical flywheel 50 so that the cylindrical openings 70, 72 are through-holes that are open both at top (as seen in FIG. 2) and bottom (not visible in the perspective view of FIG. 2). Alternatively, the cylindrical openings 70, 72 may pass most, but not all, of the way through the length L of the circular cylindrical flywheel 50 so that they are open only at one end (namely the top end as seen in FIG. 2). In this latter embodiment, there is effectively a “built-in” end cap for the cylindrical openings 70, 72 formed by the portion of material remaining after the drilling.

As shown in FIG. 3, the assembled flywheel further includes cylindrical elements 80, 82 disposed in the cylindrical openings 70, 72. In FIG. 3, one each of the cylindrical elements 80 and of the cylindrical elements 82 is shown partially inserted to illustrate their cylindrical shape, while the remaining cylindrical elements 80, 82 are shown fully inserted so that only their upper ends are visible. The cylindrical elements 80, 82 comprise a second material that is denser than the first material that makes up the circular cylindrical flywheel 50. By way of illustrative example, if the first material is stainless steel or Inconel, then the second material may be tungsten or a tungsten alloy, depleted uranium, or so forth. In some embodiments, the cylindrical elements 80, 82 comprise pieces of tungsten round bar stock. More generally, the cylindrical elements 80, 82 are suitably pieces of round bar stock of the second material. Manufacturing and assembly is simplified as the cylindrical openings 70, 72 are readily formed by drilling, and the round bar stock of the second material is cut to the correct length and inserted into the drilled openings 80, 82 in the flywheel 50.

The cylindrical openings 70, 72 (and consequently the cylindrical elements 80, 82) are preferably located outboard on the flywheel 50. That is, the cylindrical openings 70, 72 are preferably closer to the outer cylindrical surface 58 of the circular cylindrical flywheel 50 than to the axis 54 of the circular cylindrical flywheel 50. In the illustrative hollow circular cylindrical flywheel 50, the cylindrical openings 70, 72 are disposed closer to the outer cylindrical surface 58 of the hollow circular cylindrical flywheel 50 than to the inner cylindrical surface 56 of the hollow circular cylindrical flywheel 50. This arrangement increases the moment of inertia I=∫_{V} ρ(r)r² for a given mass of the second (higher density) material because it places the higher density regions (larger ρ(r)) at larger radius values. In the illustrative example of FIGS. 2 and 3, the preferentially outboard loading of the second (denser) material is further increased by making the set of cylindrical elements 80 at the more outboard radial position of larger diameter than the set of cylindrical elements 82 at the less outboard radial position. It is contemplated to employ finite element (FEL) modeling, numerical volume integration techniques, or the like to optimize the sizes and positions of the cylindrical elements of the second (higher) density material in order to maximize the moment of inertia integral I=∫_{V} ρ(r)r².

During operation, the flywheel assembly 40 is rotating as part of the rotating assembly of the RCP 22. This produces centrifugal force on the cylindrical elements 80, 82 disposed in the cylindrical openings 70, 72, which pushes the cylindrical elements 80, 82 outboard inside their respective cylindrical openings 70, 72. The round geometry advantageously results in the centrifugal force pinning each cylindrical element 80, 82 to a single defined maximally outboard position. Because of this, it is possible for the cylindrical elements 80, 82 to be disposed loosely in the cylindrical openings 70, 72 of the flywheel 50. There is no need for the cylindrical elements 80, 82 to be in a tight friction fit or to be otherwise secured inside the cylindrical openings 70, 72. The optional loose fit also can accommodate differential thermal expansion between the flywheel 50 of the first material and the cylindrical elements 80, 82 of the denser second material. A loose fit also simplifies manufacturing. However, the loose fit should be sufficiently close to avoid undue rattling or vibration of the assembled flywheel 40 during startup and shutdown of the RCP 22, and this can be optimized by optimizing the design tolerance between the outer diameter of the cylindrical elements 80, 82 and the diameter of the receiving openings 70, 72, taking into account the differential thermal expansion between the first and second material between room temperature and the design operating temperature of the RCP 22. Although a loose fit is acceptable and has some manufacturing and other advantages, it is also contemplated to employ a tight fit, e.g. friction fit, either at room temperature, or at RCP operating temperature, or at both temperatures.

Because a loose fit is acceptable, the second (more dense) material can be disposed in the cylindrical openings 70, 72 in a form other than rods or other cylindrical elements. For example, in some contemplated embodiments the cylindrical elements 80, 82 are replaced by pellets, beads, or other small pieces of the second material of a quantity sufficient to fill the cylindrical openings 70, 72. A disadvantage of this approach is that the fill factor is typically less than what can be achieved with a solid rod or other solid cylindrical element, due to air spaces between the pellets or beads. A lower fill factor translates to a lower effective density for the second material. It will also be appreciated that in variant embodiments the cylindrical openings 70, 72 can more generally be tubular openings, e.g. with non-circular cross-sections. It is also contemplated to employ tubular openings having non-circular cross-sections filled with solid tubular elements of the second (denser) material whose cross-sections comport with the tubular opening cross-section: for example, the tubular openings can have square cross-sections and the solid tubular elements can be square stock of the second material having matching square cross-sections (possibly sized to provide a loose fit).

Depending upon the nature of the second material, it may be desired to seal the second material against exposure to the coolant in the reactor pressure vessel 10. With reference to FIG. 4, a low cost approach is to weld build-up welds 90 after loading the cylindrical elements 80, 82 that seal the cylindrical openings 70, 72. If the cylindrical openings 70, 72 are through-holes, then such build-up welds are suitably formed on both the top and bottom ends of the flywheel 50 (of which only the top end is visible in the perspective view of FIG. 4). On the other hand, if the cylindrical openings 70, 72 do not pass completely through, then the sealing build-up welds 90 are suitably formed on only one side (e.g. the illustrated top side). Even if it is not desired to hermetically seal the cylindrical openings 70, 72, such build-up welds may be employed to retain the cylindrical elements 80, 82 in the cylindrical openings 70, 72, especially if a loose fit is employed.

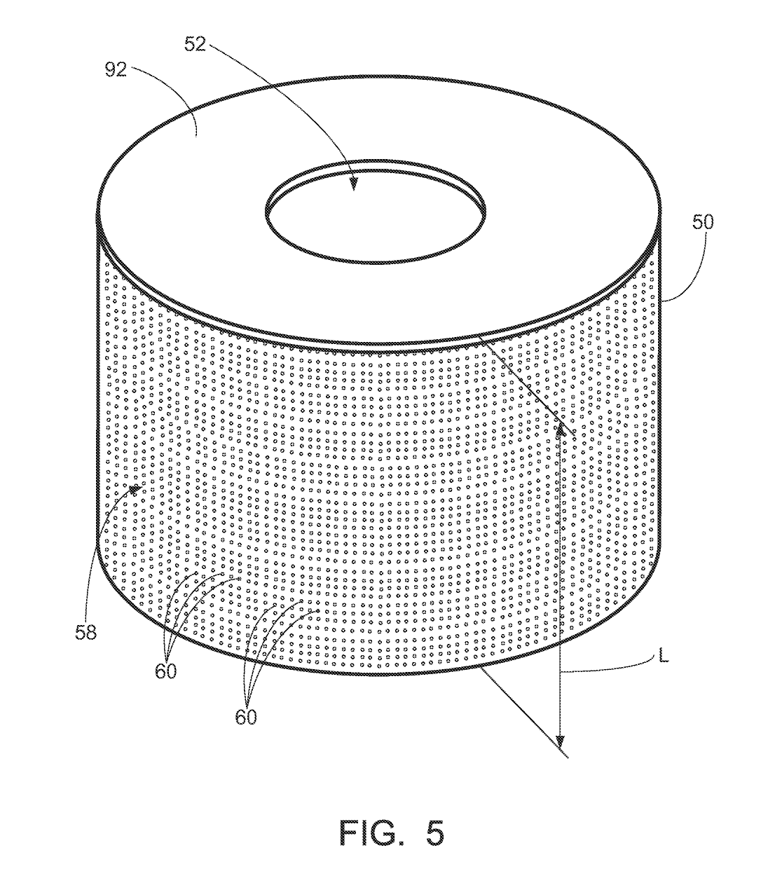

With reference to FIG. 5, in an alternative embodiment a sealing plate 92 may be used to simultaneously seal all the cylindrical openings 70, 72, for example by welding seals around the inner and outer perimeters of the illustrative annular sealing plate 92 that suitably seals the top of the hollow circular cylindrical flywheel 50. If the cylindrical openings 70, 72 are through-holes, then a similar sealing plate is suitably provided and welded to seal the bottom end of the flywheel 50. Alternatively, with reference to FIG. 4, each of the sealing build-up welds 90 can be replaced with a individual sealing plate (not shown) or a single sealing plate may cover one or more cylindrical openings 70, 72. A combination of sealing build-up welds 90 and sealing plates is also contemplated. Other approaches for securing the cylindrical elements 80, 82 in the cylindrical openings 70, 72, and for optionally sealing those openings, are contemplated. For example, in another contemplated embodiment each cylindrical opening 70, 72 includes a tapped threaded end onto which a threaded end-plug is secured after loading.

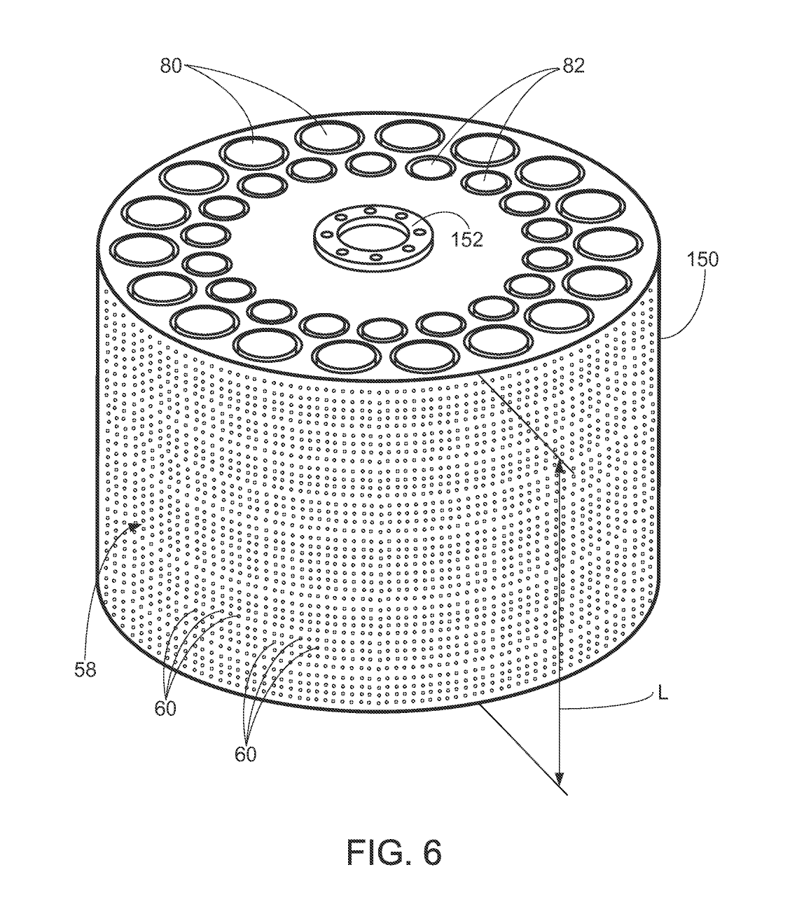

With reference to FIG. 6, a variant embodiment is illustrated at the point in manufacturing after loading the cylindrical elements 80, 82 into the cylindrical openings but before sealing the openings. In the variant embodiment of FIG. 6, the hollow (e.g. through-hole) circular cylindrical flywheel 50 is replaced by a solid circular cylindrical flywheel 150. In this embodiment a flange 152 or other connector is provided to mount the flywheel onto a drive shaft (not shown in FIG. 6). While the illustrative flywheels 50, 150 are circular cylindrical flywheels which advantageously have rotationally symmetric geometries that promote rotational stability, it is also contemplated for the flywheel to have other geometries.

The skilled artisan will readily recognize numerous advantages of the disclosed flywheel assemblies. For example, the number, diameter, and locations of the cylindrical openings 70, 72 can be chosen based on the diameter of available tungsten round bar stock. For example, the mass provided by N identical cylindrical openings each receiving 0.5-inch diameter round bar stock is equal to the mass provided by 4N cylindrical openings each receiving 0.25-inch diameter round bar stock. Thus, modifying the flywheel assembly production line to accommodate a change in available tungsten round bar stock merely amounts drilling more (or fewer) openings of different diameter. Similarly, a given flywheel (such as the flywheel 50) can be manufactured with a higher or lower moment of inertia by changing the choice of second material to provide the desired density—for example, a production line producing flywheel assemblies of a certain inertia using tungsten rods can be modified to provide higher-inertia flywheels by replacing the tungsten rods with (still) higher density depleted uranium material. Because the higher density material is preferentially located outboard, e.g., closer to the outer cylindrical surface of a circular cylindrical flywheel than to the axis of the circular cylindrical flywheel, this leaves the central region of the flywheel unmodified by the addition of the higher density material—accordingly, the flywheel can be designed to have substantially any chosen drive shaft coupling, such as the central opening 52 of the illustrative hollow circular cylindrical flywheel 50; or the coupling flange 152 of the (solid) circular cylindrical flywheel 150; or so forth. More generally, manufacturing and assembly is simplified by the optional use of stock parts such as round bar stock for the cylindrical elements 80, 82, and by the optional use of conventional drilling techniques to form the cylindrical openings 70, 72.

The disclosed flywheel assemblies have enhanced moment of inertia, which can provide various benefits. For an RCP of a given size, the enhanced flywheel moment of inertia can provide an increased coast-down time between when the RCP 22 is shut off and when rotation of the rotating assembly stops. This provides a brief period of continued coolant circulation to accommodate the initial peak residual decay heat output immediately after SCRAM. Alternatively, the enhanced flywheel moment of inertia provided by the disclosed flywheel assemblies can be used to reduce the height of the flywheel (and hence of the RCP) for a given design-basis coast-down time.

Illustrative embodiments including the preferred embodiments have been described. While specific embodiments have been shown and described in detail to illustrate the application and principles of the invention and methods, it will be understood that it is not intended that the present invention be limited thereto and that the invention may be embodied otherwise without departing from such principles. In some embodiments of the invention, certain features of the invention may sometimes be used to advantage without a corresponding use of the other features. Accordingly, all such changes and embodiments properly fall within the scope of the following claims. Obviously, modifications and alterations will occur to others upon reading and understanding the preceding detailed description. It is intended that the present disclosure be construed as including all such modifications and alterations insofar as they come within the scope of the appended claims or the equivalents thereof.

We claim:

1. An apparatus comprising:
a reactor coolant pump including:
a stator and
a rotating assembly including a rotor, an impeller, and a flywheel, the rotating assembly configured to rotate about an axis of rotation in response to the stator being electrically energized; and
wherein the flywheel comprises a first material and has a plurality of cylindrical openings whose axes are mutually parallel and are parallel with the axis of rotation of the rotating assembly, the flywheel further including cylindrical elements of a second material denser than the first material disposed in the cylindrical openings.

2. The apparatus of claim 1 wherein the first material comprises steel and the second material comprises tungsten or a tungsten alloy.

3. The apparatus of claim 1 wherein the cylindrical elements of the second material comprise pieces of tungsten round bar stock.

4. The apparatus of claim 1 wherein the flywheel is a circular cylindrical flywheel whose axis is coincident with the axis of rotation of the rotating assembly.

5. The apparatus of claim 4 wherein the cylindrical openings are closer to the outer cylindrical surface of the circular cylindrical flywheel than to the axis of the circular cylindrical flywheel.

6. The apparatus of claim 4 wherein the flywheel is a hollow circular cylindrical flywheel whose axis is coincident with the axis of rotation of the rotating assembly, and the rotating assembly of the reactor coolant pump further includes:
a drive shaft connecting the impeller and the rotor, the hollow circular cylindrical flywheel being mounted on the drive shaft which passes through the hollow circular cylindrical flywheel.

7. The apparatus of claim 6 wherein the cylindrical openings are disposed closer to the outer cylindrical surface of the hollow circular cylindrical flywheel than to the inner cylindrical surface of the hollow circular cylindrical flywheel.

8. The apparatus of claim 4 wherein the reactor coolant pump is configured as a wet rotor reactor coolant pump, and the outer cylindrical surface of the circular cylindrical flywheel has a surface texture configured to reduce fluid resistance of the rotating assembly in water.

9. The apparatus of claim 8 wherein the surface texture comprises surface dimples.

10. The apparatus of claim 4 wherein the cylindrical elements of the second material are disposed loosely in the cylindrical openings of the circular cylindrical flywheel.

11. The apparatus of claim 1 wherein the cylindrical elements of the second material are disposed loosely in the cylindrical openings of the flywheel.

12. The apparatus of claim 1 wherein the flywheel further includes weld buildup sealing the cylindrical openings with the cylindrical elements of the second material disposed in the cylindrical openings.

13. The apparatus of claim 1 further comprising:
a nuclear reactor including:
a reactor pressure vessel and
a nuclear reactor core comprising fissile ²³⁵U disposed in the reactor pressure vessel;
wherein the reactor coolant pump is disposed on or in the reactor pressure vessel with the impeller of the reactor coolant pump arranged to engage coolant water disposed in the reactor pressure vessel.

14. A method comprising:
providing a flywheel comprising a first material;
drilling cylindrical openings in the flywheel oriented parallel with an axis of rotation of the flywheel;
disposing a second material that is more dense than the first material in the cylindrical openings; and
after disposing the second material in the cylindrical openings, sealing the cylindrical openings.

15. The method of claim 14 wherein the disposing comprises:
disposing pieces of round bar stock of the second material in the cylindrical openings.

16. The method of claim 14 wherein the sealing comprises:
welding a build-up weld to seal each cylindrical opening.

17. The method of claim 14 further comprising:
mounting the flywheel on the rotating assembly of a reactor coolant pump.

18. An apparatus comprising:
a reactor coolant pump including:
a stator and
a rotating assembly including a rotor, an impeller, and a flywheel, the rotating assembly configured to rotate about an axis of rotation in response to the stator being electrically energized; and
wherein the flywheel comprises a first material and has a plurality of mutually parallel tubular openings filled with a second material that is denser than the first material.

19. The apparatus of claim 18 wherein the second material is tungsten, a tungsten alloy, or depleted uranium.

20. The apparatus of claim 18 wherein the mutually parallel tubular openings are filled with the second material comprising pellets, beads, or rods.

21. The apparatus of claim 18 wherein the flywheel further comprises build-up welds sealing the parallel tubular openings.

22. The apparatus of claim 18 wherein the flywheel further comprises at least one end plate sealing the parallel tubular openings.
